(19) United States
(12) Patent Application Publication
(10) Pub. No.: US 2015/0196955 A1
(43) Pub. Date: Jul. 16, 2015

(54) SEALING APPARATUS

(71) Applicant: GOOPER HERMETIC LTD., Hadera (IL)

(72) Inventor: Philip NAFTALIN, Hadera (IL)

(21) Appl. No.: 14/669,483

(22) Filed: Mar. 26, 2015

Related U.S. Application Data
(63) Continuation-in-part of application No. 12/253,978, filed on Oct. 19, 2008, now abandoned.
Application No. 12/253,978 is a continuation-in-part of application No. 11/875,823, filed on Oct. 19, 2007, now abandoned.

(51) Int. Cl. B22F 3/00; A41F 1/00; B23K 26/34; A44B 18/00; B29C 67/00; B22F 3/105

(52) U.S. Cl. CPC B22F 3/008; B29C 67/0077; B22F 3/1055; B29C 67/0055; B23K 26/345; A44B 18/0069; A41F 1/002; B29L 2031/727

(57) ABSTRACT

A water impermeable sealing apparatus. The apparatus includes a first sealing strip having a base that has a first set of fastener elements carried on its surface in two spaced-apart areas. Extending along the first surface of the base between the two areas of the first set of fastener elements, a first sealing element protrudes from the base. A complementary second sealing strip also includes a base with a second set of fastener elements on its surface in two spaced-apart areas. Extending along the surface of the base between the two areas of the second set of fastener elements, a second sealing element protrudes from the base for non-interlocking engagement of the first sealing element when the first and second fastener elements are engaged.

### FIELD OF THE INVENTION

This application relates generally to a sealing apparatus usable in textile applications. More specifically, this application relates to a sealing apparatus that can be applied to manufactured article.

### BACKGROUND OF THE INVENTION

Recent years have led to an increase in carry-on gadgets which are destructible when exposed to water. These objects, such as mobile phones, tablets and other electronic devices, are being carried on a regular basis in clothing pockets, hand bags or being put in any other manufactured article. Therefore, a sealed compartment in a manufactured article, which is impermeable to water, has gained increasing developmental efforts. Hook and loop style separable fasteners, for example, are well known and are used to join two members detachably to each other. However, such fasteners as those available today are prone to water leaks. Other, more sophisticated assemblies, are made of various components which render them cumbersome to assemble and apply onto the manufactured article.

Thus, there is a long felt need for a sealing apparatus usable in manufactured articles, which is both completely impermeable to liquids, and is accessible and easily assembled onto the article.

### SUMMARY OF THE INVENTION

Described herein is a sealing apparatus that combines the functionality of megnetic fasteners with the smooth manufacturing of 3D printing, creating a sealing mechanism such that the apparatus is both water impermeable and readily assembled. Application of the disclosed sealing apparatus to manufactured goods provides a simple waterproof seal, which can be utilized tier various items with closeable openings such as pockets, bags, coolers, windows, doors etc., while being printed in 3D printing enables the accessible and effortless incorporation into the manufactured articles.

The apparatus is of simple construction and can be used anywhere it is it is desirable to have a simple mechanism of creating a separable water impermeable seal. The sealing apparatus utilizes a combination of magnetic elements configurations such that when the apparatus is engaged, a water impermeable seal is created.

It is thus an object of the present invention to provide a sealing apparatus usable in manufactured applications, the apparatus comprising: a first sealing strip having an embedded region embedded with a first at least one magnet or a first at least one magnet reactive material; a second sealing strip having an embedded region embedded with a second at least one magnet or a second at least one magnet reactive material; wherein a magnetic force of attraction is generated between the first sealing strip and the second sealing strip when the first and second sealing strips are brought together, thereby creating a seal;

It is another object of the present invention to provide the abovementioned sealing apparatus, wherein the first sealing strip and second sealing strip are manufactured using three-dimensional printing.

It is another object of the present invention to provide the abovementioned sealing apparatus, wherein the first and second at least one magnet or the first and second at least one magnet reactive material are manufactured using three-dimensional printing.

It is another object of the present invention to provide the abovementioned sealing apparatus, wherein the apparatus is directly three-dimensionally printed onto the manufactured application.

It is another object of the present invention to provide the abovementioned sealing apparatus, wherein the three-dimensional printing is executed using a material selected from the group consisting of: an elastomeric material, a biodegradable material, a recyclable material, ABS plastic, polylactide, polyamide, glass filled polyamide, epoxy resins, silver, platinum, gold, titanium, steel, wax, photopolymers, polycarbonate, graphite, graphene, cornstarch, cellulose and any combination thereof.

It is another object of the present invention to provide the abovementioned sealing apparatus, wherein the three-dimensional printing is executed in a method selected from the group consisting of: selective laser melting (SLM) or direct metal laser sintering (DMLS), selective laser sintering (SLS), fused deposition modeling (FDM),[28] or fused filament fabrication (FFF), stereolithography (SLA), laminated object manufacturing (LOM) and any combination thereof.

It is another object of the present invention to provide the abovementioned sealing apparatus, wherein the first sealing strip further comprises a first flanged portion connected to and projecting from one side of the embedded region and integral with the embedded region; and a second flanged portion connected to and projecting from the other side of the embedded region and integral with the embedded region; and the second sealing strip further comprises a third flanged portion connected to and projecting from one side of the embedded region and integral with the embedded region, and a fourth flanged portion connected to and projecting from the other side of the embedded region and integral with the embedded region.

It is another object of the present invention to provide the abovementioned sealing apparatus, wherein the first, second, third and fourth flanged portions are manufactured using three-dimensional printing.

It is another object of the present invention to provide the abovementioned sealing apparatus, wherein each one of the first at least one magnet or first at least one magnetic reactive material is located along the first sealing strip such that it comes into mutual magnetic attraction with one of the second at least one magnet or second at least one magnetic reactive material when the first elastomeric sealing strip is placed in longitudinal abutment with the second elastomeric sealing strip, and wherein a magnetic force of attraction is generated between the first sealing strip and the second sealing strip, thereby creating a seal; and

It is another object of the present invention to provide the abovementioned sealing apparatus, wherein the first flanged portion is tapered such that its thickness progressively decreases with increasing distance from the center of the first sealing strip and the second flanged portion is tapered such that its thickness progressively decreases with increasing distance from the center of the first sealing strip, and the third flanged portion is tapered such that its thickness progressively decreases with increasing distance from the center of the second sealing strip and the fourth flanged portion is tapered such that its thickness progressively decreases with increasing distance from the center of the second sealing strip.

It is another object of the present invention to provide the abovementioned sealing apparatus, wherein the flanged portions of the first and second sealing elements further comprise fastener elements carried on each side of the embedded regions, such that when the first sealing strip and the second sealing strips are brought together, the fastener elements engage one another.

It is another object of the present invention to provide the abovementioned sealing apparatus, wherein the fastener elements are manufactured using three-dimensional printing.

It is another object of the present invention to provide the abovementioned sealing apparatus, wherein the fastener elements comprise hooks and hook-engageable fibers.

It is another object of the present invention to provide the abovementioned sealing apparatus, wherein the first sealing strip has a first footprint area, and the second sealing strip has a second footprint area equal in width to that of the first footprint area.

It is another object of the present invention to provide the abovementioned sealing apparatus, wherein the first embedded region has concavity, and the second embedded region has convexity which interfittingly cooperates with the concavity of the first embedded region.

It is another object of the present invention to provide the abovementioned sealing apparatus, wherein the first embedded region has flat surfaces at its concavity, and the second embedded region has flat surfaces at its convexity.

It is another object of the present invention to provide the abovementioned sealing apparatus, wherein each one of the first at least one magnet or first at least one magnet reactive material are contained within the first embedded region and centered within the concavity of the first sealing strip, and wherein each one of the second at least one magnet or the second at least one magnet reactive material are centered within the convexity of the second sealing strip.

It is another object of the present invention to provide the abovementioned sealing apparatus, wherein there is one-to-one correspondence between each one of the first at least one magnet or first at least one magnetic reactive material and each one of the second at least one magnet or second at least one magnetic reactive material.

It is another object of the present invention to provide the abovementioned sealing apparatus, further comprising a first membrane connectable to the first sealing strip, such that the at least one magnet or at least one magnet reactive material are embedded within the first sealing strip and the first membrane; and, the sealing apparatus further comprises a second membrane connectable to the second sealing strip, such that the at least one magnet or at least one magnet reactive material are embedded within the second sealing strip and the second membrane.

It is also an object of the present invention to disclose a method of manufacturing of a sealing apparatus usable in manufactured applications, characterized by: providing a first sealing strip; providing a second sealing strip; embedding at least one magnet or at least one magnet reactive material onto the first sealing strip; embedding at least one magnet or at least one magnet reactive material onto the second sealing strip; incorporating the first and second sealing strips into the manufactured application; and bringing together the first and second sealing strips, thereby generating a magnetic force of attraction between the first sealing strip and the second sealing strip, thus creating a seal.

It is another object of the present invention to provide the aforementioned method, further comprising the step of three-dimensional printing the first and second sealing strips.

It is another object of the present invention to provide the aforementioned method, further comprising the step of three-dimensional printing the first and second at least one magnet or the first and second at least one magnet reactive material directly onto the first sealing strip or the second sealing strip, respectively.

It is another object of the present invention to provide the aforementioned method, wherein the step of incorporating the first and second sealing strips into the manufactured application is done by direct three-dimensional printing onto the manufactured application.

It is another object of the present invention to provide the aforementioned method, further comprising the step of executing the three-dimensional printing using a material selected from the group consisting of: an elastomeric material, a biodegradable material, a recyclable material, ABS plastic, polylactide, polyamide, glass filled polyamide, epoxy resins, silver, platinum, gold, titanium, steel, wax, photopolymers, polycarbonate, graphite, graphene, cornstarch, cellulose and any combination thereof.

It is another object of the present invention to provide the aforementioned method, further comprising the step of executing the three-dimensional printing using a method selected from the group consisting of: selective laser melting (SLM) or direct metal laser sintering (DMLS), selective laser sintering (SLS), fused deposition modeling (FDM),[28] or fused filament fabrication (FFF), stereolithography (SLA), laminated object manufacturing (LOM) and any combination thereof.

It is another object of the present invention to provide the aforementioned method, further comprising the steps of connecting a first flanged portion to one side of the embedded region of the first sealing strip being projected from one side of the embedded region and integral with the embedded region, and connecting a second flanged portion to second side of the embedded region of the first sealing strip being projected from second side of the embedded region and integral with the embedded region; and connecting a third flanged portion to one side of the embedded region of the second sealing strip being projected from one side of the embedded region and integral with the embedded region, and connecting a fourth flanged portion to second side of the embedded region of the second sealing strip being projected from second side of the embedded region and integral with the embedded region.

It is another object of the present invention to provide the aforementioned method, further comprising the step of three-dimensional printing the first, second, third and fourth flanged portions.

It is another object of the present invention to provide the aforementioned method, further comprising the step of locating the each one of the first at least one magnet or first at least one magnetic reactive material along the first sealing strip such that it comes into mutual magnetic attraction with one of the second at least one magnet or second at least one magnetic reactive material when the first elastomeric sealing strip is placed in longitudinal abutment with the second elastomeric sealing strip, and wherein a magnetic force of attraction is generated between the first sealing strip and the second sealing strip, thereby creating a seal; and

It is another object of the present invention to provide the aforementioned method, further comprising the step of incorporating fastener elements carried on each side of the embedded regions, such that when bringing together the first sealing strip and the second sealing strips, the fastener elements engage one another, and optionally, three-dimensional printing the fastener elements.

In particular, this application discloses a water impermeable sealing apparatus usable in manufactured applications, the apparatus comprising: a first sealing strip having a base comprising a first and second surface wherein the base portion includes a first set of fastener elements carried on the first surface of the base in two spaced-apart areas; extending along the first surface of the base between the two areas of the first set of fastener elements, a first sealing element protruding from the first side of the base; a second sealing strip having a base comprising a first and second surface wherein the base portion includes a second set of fastener elements carried on the first surface of the base in two spaced-apart areas; and, extending along the first surface of the base between the two areas of the second set of fastener elements, a second sealing element protruding from the first side of the base for non-interlocking engagement of the first sealing element when the first and second fastener elements are engaged.

This application also discloses a water impermeable sealing apparatus usable in manufactured applications, the apparatus comprising: a first sealing strip having a base comprising a first and second surface wherein the base portion includes a first set of fastener elements carried on the first surface of the base in two spaced-apart areas; extending along the first surface of the base between the two areas of the first set of fastener elements, a first sealing element protruding from the first side of the base; a second sealing strip having a base comprising a first and second surface wherein the base portion includes a second set of fastener elements carried on the first surface of the base in two spaced-apart areas; extending along the first surface of the base between the two areas of the second set of fastener elements, a second sealing element protruding from the first side of the base for non-interlocking engagement of the first sealing element when the first and second fastener elements are engaged; wherein at least one of the first and second sealing elements are magnetic such that a force of attraction is generated when the first and second sealing strips are brought together; and, wherein the base portion of at least one of the sealing strips is water impermeable.

This application further discloses a water impermeable sealing apparatus usable in manufactured applications, the apparatus comprising: a first sealing strip having a base comprising a first and second surface wherein the base portion includes a first set of fastener elements carried on the first surface of the base in two spaced-apart areas; extending along the first surface of the base between the two areas of the first set of fastener elements, a first sealing element protruding from the first side of the base; a second sealing strip having a base comprising a first and second surface wherein the base portion includes a second set of fastener elements carried on the first surface of the base in two spaced-apart areas; extending along the first surface of the base between the two areas of the second set of fastener elements, a second sealing element protruding from the first side of the base for non-interlocking engagement of the first sealing element when the first and second fastener elements are engaged; wherein the first sealing element is made of a compressible material and the second sealing surface is wedge shaped such that when the first and second sealing strips are engaged, the wedged surface of the second sealing surface compresses the material of the first sealing element thereby creating a continuous water impermeable seal between the first and second sealing elements; and, wherein the base portion of at least one of the sealing strips is water impermeable.

This application also discloses a sealing apparatus usable in manufactured applications, the apparatus comprising: a first sealing strip having an embedded region embedded with at least one magnet or at least one magnet reactive material; a second sealing strip having an embedded region embedded with at least one magnet or at least one magnet reactive material; wherein a magnetic force of attraction is generated between the first sealing strip and the second sealing strip when the first and second sealing strips are brought together, thereby creating a seal.

This application further discloses a sealing apparatus usable in manufactured applications, the apparatus comprising: an elastomeric first sealing strip having an embedded region embedded with at least one magnet or at least one magnet reactive material; flanged portions to each side of the embedded region and integral with the embedded region; fastener elements carried on the flanged portions on each side of the embedded region, an elastomeric second sealing strip having an embedded region embedded with at least one magnet or at least one magnet reactive material; flanged portions to each side of the embedded region and integral with the embedded region; fastener elements carried on the flanged portions on each side of the embedded region; wherein a magnetic force of attraction is generated between the first sealing strip and the second sealing strip when the first and second sealing strips are brought together, thereby creating a seal; and, wherein when the first sealing strip and the second sealing strips are brought together, the fastener elements engage one another.

It is another object of the present invention to disclose the sealing closure as defined above, wherein the magnetic elements are made of a material selected from the group consisting of: Neodymium, Neodymium Iron Boron (NdFeB), Samarium-Cobalt, Electromagnet, any other type of rare-earth magnet, and any combination thereof.

It is another object of the present invention to disclose the sealing closure as defined above having a stable sealing by providing membranes which are thin enough, so that the magnets or magnetic reactive materials will be close enough to each other when they attract each other.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a perspective view of a first embodiment of the sealing apparatus shown with the sealing strips separated;

FIG. 2 is a perspective view of the apparatus in FIG. 1 showing the two sealing strips engaged;

FIGS. 3-5 sequentially illustrate the engagement of the two sealing strips of the apparatus in FIG. 1;

FIG. 6 is a perspective view of a second embodiment of the sealing apparatus shown with the sealing strips separated;

FIG. 7 is a perspective view of the apparatus in FIG. 6 showing the two sealing strips engaged;

FIG. 8 is a perspective view of a third embodiment of the sealing apparatus shown with the sealing strips separated;

FIG. 9 is a perspective view of the apparatus in FIG. 8 showing the two sealing strips engaged;

FIGS. 10-12 sequentially illustrate the engagement of the two sealing strips of the apparatus in FIG. 8;

FIG. 13 is a perspective view of a further embodiment of the invention, with two sealing strips partly abutting and connected, and partly drawn away from one another;

FIG. 14 is a perspective view of one of the sealing strips of FIG. 13;

FIG. 15 is an end view of two opposed sealing strips according to a further embodiment of the invention, shown spaced apart from one another;

FIG. 16 is an end view of two opposed sealing strips according to a still further embodiment of the invention, shown spaced apart from one another;

FIG. 17 is an end view of two opposing sealing strips according to yet another embodiment of the invention, shown spaced apart from one another;

FIG. 18 is an end view of two opposing sealing strips according to still another embodiment of the invention, shown spaced apart from one another;

FIG. 19 is an end view of two opposing sealing strips according to an additional embodiment of the invention, shown spaced apart from one another;

FIG. 20 is an end view of two opposing sealing strips according to yet another additional embodiment of the invention, shown spaced apart from one another;

FIG. 21 illustrates a cross section of the initial stages of building of the magnetic strip;

FIG. 22 illustrates a cross section of later stages of the manufacturing of the magnetic strip;

FIG. 23 illustrates the addition of a laminating membrane to the sealing strip;

FIG. 24 illustrates an embodiment wherein it e magnetic waterproof seal is comprised of two identical magnetic strips;

FIG. 25 illustrates an embodiment of the three-dimensional printing of the magnetic strip, providing an irregular shape;

FIG. 26 illustrates an embodiment of the three-dimensional printing of the sealing apparatus; and

FIG. 27 illustrates an embodiment in which three-dimensional printing is being used to manufacture the sealing apparatus.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The term ‘sealing’ refers hereinafter to a fastening procedure which provides a tight and/or hermetic closure, and/or to provide a closure which excludes passage of different materials (e.g., water, gas, air, etc.) through the sealing closure.

The term ‘manufacturing article’ is used interchangeably with the term ‘manufacturing goods’ or ‘manufacturing application’ and is referred hereinafter to any article which is manufactured and is being used in applications such as packaging, storage, military, medical, agriculture, food, outdoor activities, construction, fashion, textile, including articles such as, but not limited to, clothes, bags, windows for buildings, rooms, vehicles , aircraft, and waterborne craft, doors, construction orifices, coolers, furniture, military equipment, and the like. The articles may be made of any material, whether rigid, non-rigid, semi-rigid, transparent, translucent, opaque, etc.

The term ‘about’ refers hereinafter to an accuracy of a predetermined measure within a certainty of ±25%.

The term ‘ferromagnetic material’ refers hereinafter to any material to which a magnetic material is able to be magnetically attracted. For example, the term ‘ferromagnetic material’ may refers to: iron, nickel, cobalt, some alloys of rare earth metals, and some naturally occurring minerals such as lodestone.

The term ‘sealable device’ refers hereinafter to any device which is able to be sealed by the sealing closure of the present invention, For example, the sealable device may be: a pouch, a bag, a sack, a pocket, a device useful for sterile purposes, a waterproof money belt, a waterproof pocket, a door with a frame, a tent, a greenhouse, a waterproof pocket, or any combination thereof.

The term ‘magnetic elements’ refers hereinafter to any type of elements which may be made of a strong magnetic material such as: Neodymium (e.g., Neodymium Iron Boron (NdFeB)), Samarium-Cobalt or any other type of rare-earth magnet or composition of materials).

According to some embodiments, the ‘magnetic element’ may be an electromagnetic element which is well known in the art.

The term ‘plurality’ refers hereinafter to at least one object.

The term ‘elastomeric material’ refers hereinafter to all elastic, rubber-like substances which can be elongated or compressed to a dimension at least about 50% changed from the original dimension.

The term ‘biodegradable material’ refers hereinafter to materials that are degraded by the body's enzymatic and/or hydrolytic pathways through a reaction against “foreign” material, such as in a non-limiting example, Polydioxanone (PDO), Polycaprolactone (PCL), Polylactic acid (PLA), Polyglycolic acid (PGA), Adipic acid, PEG and glutamic acid.

The present invention discloses a novel magnetic sealing closure 100 usable in various fields, as will be presented below.

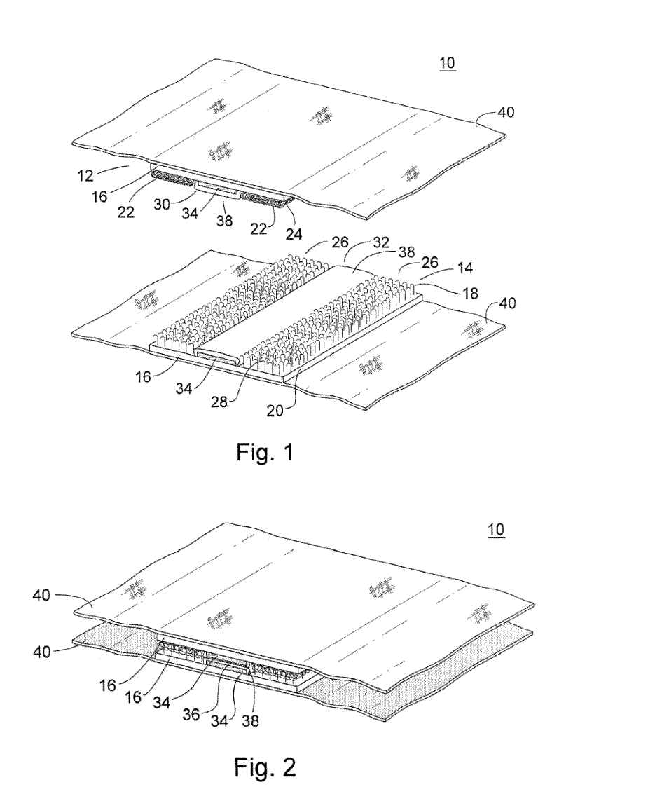

FIGS. 1 and 2 show a first embodiment of the sealing apparatus 10 of the present invention. The device 10 includes a first sealing strip 12 and a second sealing strip 14, each including a base 16 with first 18 and second surfaces 20. The base portion 16 of the first sealing strip 12 includes a first set of fastener elements 22 carried on the first surface 18 in two spaced-apart areas. As shown, the first fastener elements 22 are comprised of loop 24 structures as is common in hook and loop fasteners. The base portion 16 of the second sealing strip 14 includes a second set of fastener elements 26 carried on the first surface 18 in two spaced-apart areas. The second fastener elements 26 are comprised of hook structures 28. It should be appreciated that the hook and loop structures may be located on the opposite strips and be equally effective, Further, besides the hook and loop fastener elements shown in the figures, many other loop or fiber engaging shapes may be used, such as mushrooms, palm trees, or canted spikes.

Extending along the first surface 18 of the base portions 16, between the two areas of the first 22 and second 26 sets of fastener elements, are first 30 and second 32 sealing elements. The sealing elements are fixably attached and protrude from the base portions 16. And in the first embodiment, are comprised of planer magnets 34. The magnets 34 are oriented such that the opposite poles face each other and a force of attraction is generated when the first 12 and second 14 sealing strips are brought together. Thus, when the first 12 and second 14 sealing strips are brought together, the first 22 and second 26 fastening elements, and more specifically the loop 24 and hook 28 portions, engage each other and the magnets 34 of the first 30 and second 32 sealing elements engage one another in a non-interlocking manner, such that a water impermeable seal 36 is created. As used herein, the term “non-interlocking” refers to a seal that is distinguishable from a seal that relies on the complementary pairing of male and female components such as with a “ZIPLOC” or similar interlocking devices. It should be appreciated that the apparatus may also utilize just one magnet on one of the sealing strips that may engage with a magnet attractive surface on the opposite sealing strip and still be effective in creating a seal.

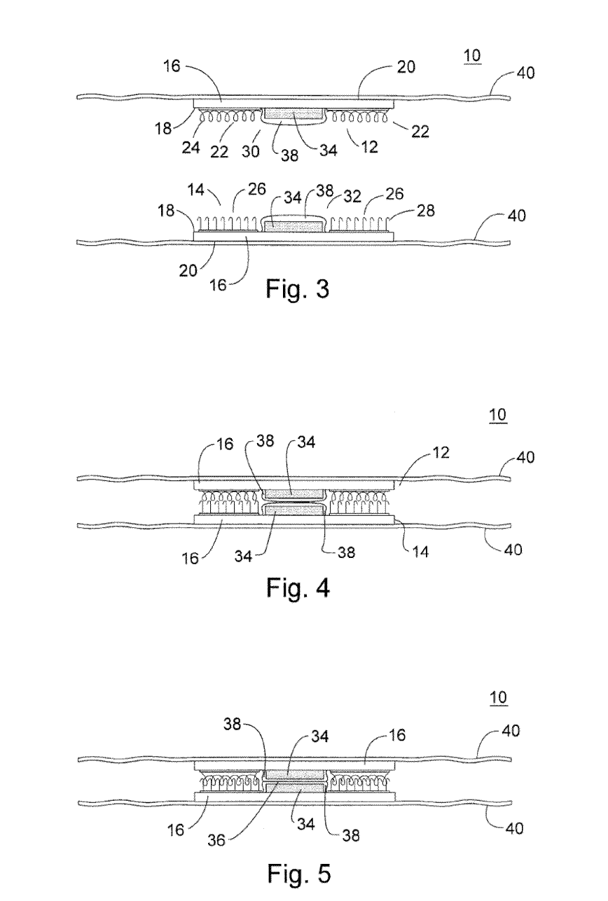

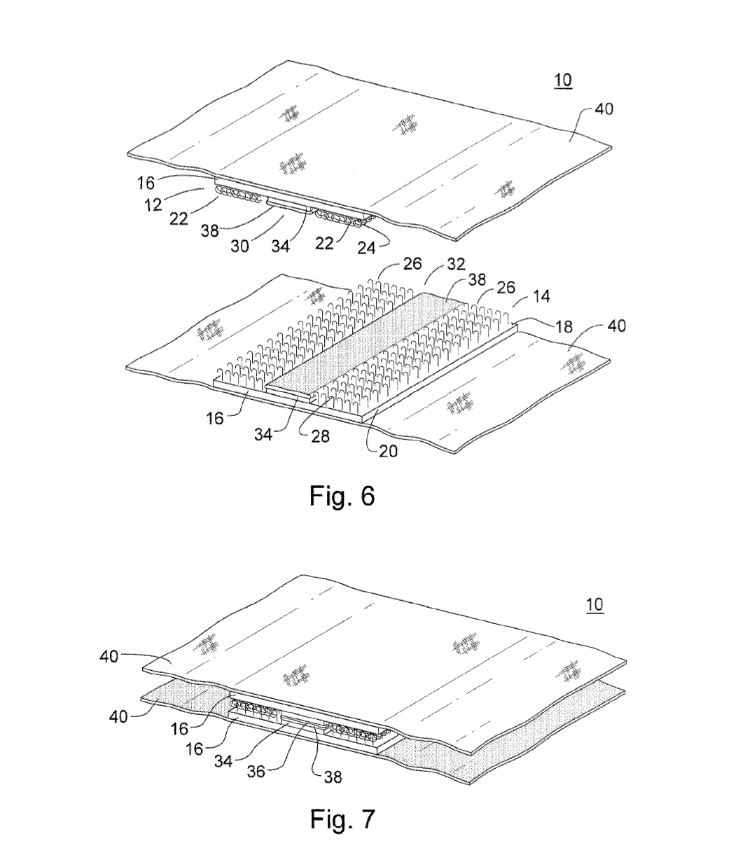

To assist in the water impermeable nature of the apparatus 10, the sealing surface of the magnets are preferably covered with an elastomeric material 38 such as rubber, latex, silicon, or like material that is resiliently compressible under a given amount of pressure. The elastomeric material 38 on the surface of the magnets 34 is at least partially compressed when the sealing strips are pressed together during the initial sealing of the apparatus 10. The compression is maintained due to the fastener elements and sealing elements acting in cooperation when the sealing strips are engaged. See FIGS. 3-5. The elastomeric material can substantially cover the magnets as shown in FIGS. 1-5, completely cover, or, alternatively, it may be applied to just the sealing surface as shown in FIGS. 6 and 7. An additional means to increase the water impermeable nature of the apparatus 10 is utilize at least one water impermeable base portion 16. Alternatively, the second surface 20 of the base portion 16 may be bound to a water impermeable layer 40. Suitable water impermeable materials for the base 16 or layer 40 are well known in the art and include synthetic polymers.

Regarding the magnets 34 used in the sealing elements, it is contemplated by the inventors that they could be of various shapes and sizes. For example, cylindrical magnets if covered or encapsulated in an elastomeric material that is molded to create a surface that is substantially planer would be effective as a seating element.

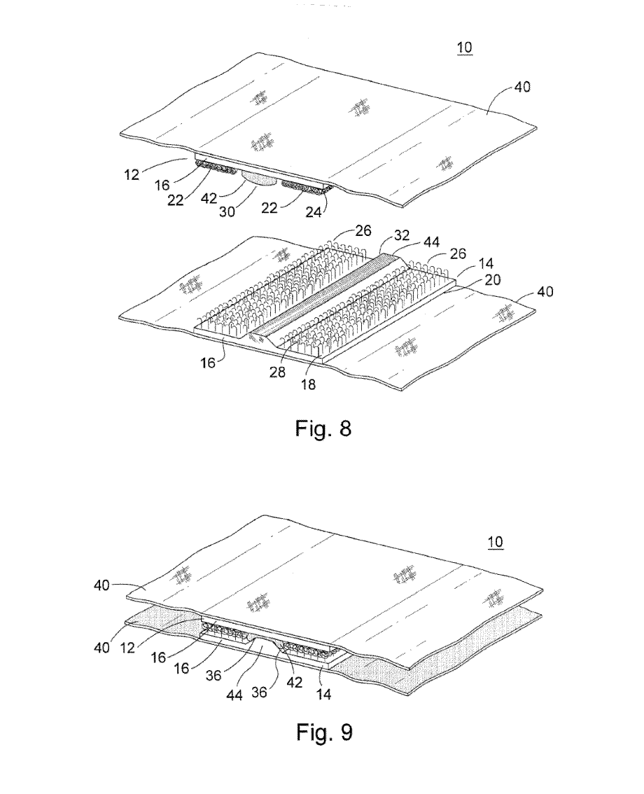

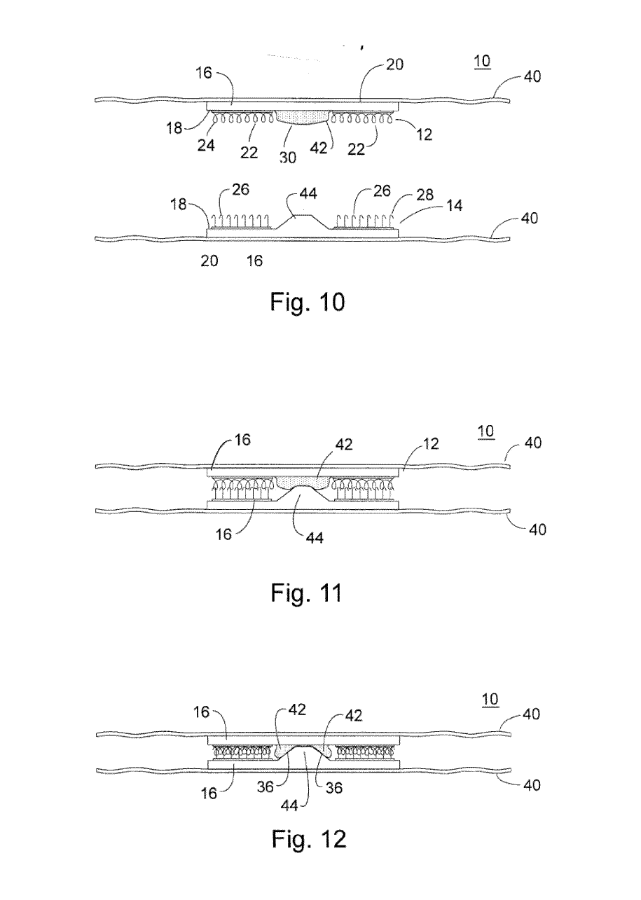

Referring now to FIGS. 8-12, shown therein is an additional embodiment of the sealing apparatus 10. In this embodiment, the structures described above are the same except of the sealing elements. In this embodiment, the sealing elements are comprised of a resilient compressible portion 42 and a wedge portion 44. As shown, the resilient compressible portion 42 extends along the first surface 18 of the base portion 16 of the first sealing strip 12, and more specifically, between the two areas of the first fastener element 22. Likewise, the wedge portion 44 extends along the first surface 18 of the base portion 16 of the second sealing strip 14, and more specifically, between the two areas of the second fastener element 26. In this embodiment, the sealing wedged portion 44 is protrudes from the base portion 16. Thus, when the first 12 and second 14 sealing strips are brought together, the first 22 and second 26 fastening elements engage each other. This in turn causes the wedged surface 44 of the second sealing surface to compresses the resilient portion 42 of the first sealing element, thereby creating a continuous water impermeable seal 36 in a non-interlocking manner. The compression of the resilient portion 42 and resultant water impermeable seal 36 is maintained due to the fastener elements holding the first 12 and second 14 sealing strips together. See FIGS, 10-12. The wedge portion 44 may be made of a relatively rigid material such as rubber, plastic or other polymer. The compressible portion 42 should be sufficiently compressible such that when the wedge portion 44 comes in contact with it during the engagement of the sealing strips, it deforms the compressible portion 42 to a degree so at to create the water impermeable seal 36. Examples of compressible materials include urethane foam, pliable rubber, and silicon. It will therefore be understood that reference to elastomeric and polymeric materials will encompass both essentially inorganic substances as well as organic substances and combinations of the two.

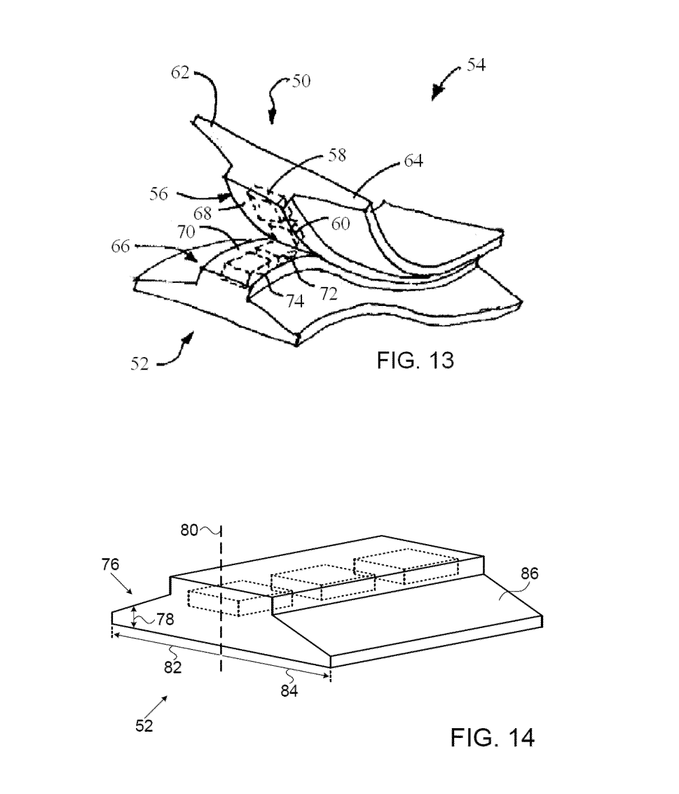

FIG. 13 shows an embodiment of the invention wherein magnetic attraction is employed to releasably connect a first elastomeric sealing strip 50 to a second elastomeric sealing strip 52. The first elastomeric sealing strip 50 and the second elastomeric sealing strip 52 collectively form a sealing apparatus 54 which, like the previously described sealing apparatuses such as the sealing apparatus 10, may be usable in for example manufactured applications.

The nature of the first and second elastomeric sealing strips 50, 52 will be made using the sealing strip 50 for illustration. The second elastorneric sealing strip 52 may be a mirror image of the first elastomeric sealing strip 50. The first elastomeric sealing strip 50 may comprise a first embedded region 56 embedded with a plurality of first magnets 58, 60 or alternatively with a plurality of first individual pieces of magnetic reactive material. It will be appreciated that if magnets are provided in one of the first elastomeric sealing strip 50 and the second elastomeric sealing strip 52, then the other need have only a magnet reactive material to assure operable magnetic attraction. It does not matter which of the first and second elastomeric sealing strips 50, 52 has magnets.

The first elastomeric sealing strip 50 comprises a first flanged portion 62 connected to and projecting from one side of the embedded region 56 and integral therewith, and a second flanged portion 64 connected to and projecting from the other side of the embedded region 56 and integral therewith. As depicted herein, projection of the first and second flanged portions 62, 64 is such that these first and second flanged portions may be (but are not necessarily) coplanar and in mirror image arrangement. Because of this mirror image relationship, it may be said that the first elastomeric sealing strip 50 has a first footprint area which would correspond to the plan view that would be observed for example from above in FIG. 13 if the first elastomeric sealing strip 50 were laid out flat and viewed in plan, and the second elastomeric sealing strip 52 has a corresponding and similar second footprint area equal in width to that of the first footprint area.

The first elastomeric sealing strip 50 releasably connects to the second elastomeric sealing strip 52 when the respective magnetic members, which may be magnets or magnetic reactive materials, come into sufficient proximity such that magnetic attraction ensues. The embedded region 56 and its counterpart embedded region 66 of the second elastomeric sealing strip 52 have respective contact surfaces 68, 70, which due to the resilient or compressible nature of their constituent material, form sealing surfaces when the first and second elastomeric sealing strips 50, 52 are magnetically adhered to one another.

To this end, each one of the first magnets 58, 60 (or first individual pieces of magnetic reactive material) is located along the first elastomeric sealing strip 50 such that it comes into mutual magnetic attraction with one of the second magnets 72,74 (or second individual pieces of magnetic reactive material) when the first elastomeric sealing strip 50 is placed in longitudinal abutment with the second elastomeric sealing strip 52, and wherein a magnetic force of attraction is generated between the first elastomeric sealing strip 50 and the second elastorneric sealing strip 52, thereby creating the seal.

FIG. 14 shows an elastomeric sealing strip, such as the elastorneric sealing strip 52 isolated from its opposed counterpart. It will be seen that a flanged portion 76 of the elastomeric sealing strip 52 is tapered such that its thickness (represented by the arrow 78 at one illustrative point along the flanged portion 76) progressively decreases with increasing distance from the center of the elastomeric sealing strip 52. The center, for purposes of determining increasing distance from the center, is represented by the projection line 80. Increasing distances to the right and to the left of the projection line are indicated by the arrows 82 and 84. The other flanged portion 86 displays similar characteristics albeit in mirror image. Again, recalling that the corresponding mating elastomeric sealing strip, such as the elastomeric sealing strip 50, may be a mirror image, the same characteristics may be present.

It should be mentioned at this point that in FIGS. 13 and 14, magnets or the like, such as the magnets 58, 60, 72, 74 in FIG. 13, which are shown in broken lines, are so shown merely to emphasize that they are embedded within their associated sealing strips, such as the sealing strips 50, 52. Because the constituent material of the sealing strips may be opaque, translucent, or transparent, the broken line rendering of these magnets or the like should not be taken to support a conclusion that they are literally concealed from view in their respective sealing strips.

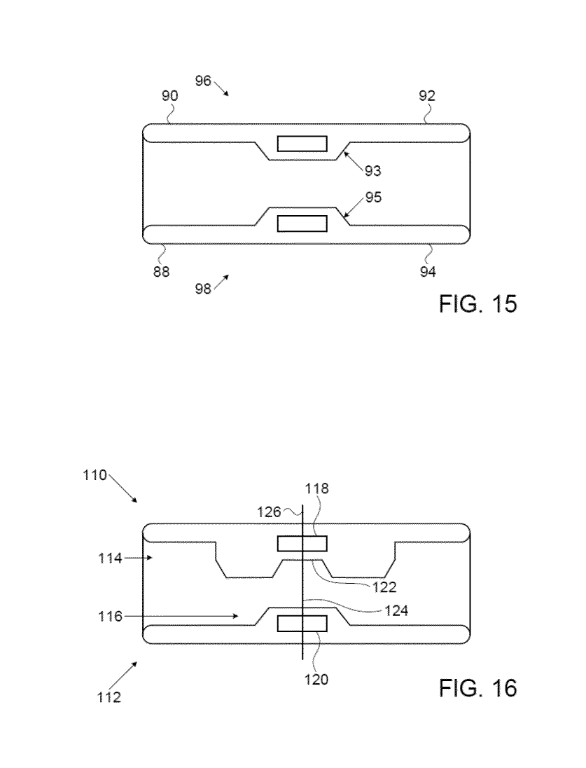

FIG. 15 shows another embodiment of the invention wherein flanged portions 88, 90, 92, 94 of two corresponding, mutually mating elastomeric sealing strips 96, 98 are not tapered. Magnets 100, 102 (or corresponding magnetic reactive materials) are seen in this end view of the elastomeric sealing strips 96 and 98

FIG. 16 shows a further embodiment of the invention wherein two corresponding, mutually mating elastorneric sealing strips 110, 112 have respective embedded regions 114, 116 which are adapted to interfit. Each embedded region 114 or 116 has a plurality of magnets 118 or 120 (or corresponding magnetic reactive materials). The embedded region 114 has a downwardly facing surface 122 (as seen in FIG. 16) which displays concavity. The embedded region 116 has a corresponding upwardly facing surface 124 (as seen in FIG. 16) which displays convexity which interfittingly cooperates with the concavity of the embedded region 114. The individual faces of the downwardly facing surface 122 and of the upwardly facing surface 124 are fiat or planar, although this may be modified as desired. As is clearly shown in FIG. 16, each one of the magnets 118 and 120, and of those which are concealed behind the magnets 118 and 120, is contained within its respective embedded region 114 or 116. Each one of the magnets 118 is centered within the concavity of the elastomeric sealing strip 110, and each one of the magnets 120 and those magnets (or magnetic reactive materials) concealed therebehind in the view of FIG. 16 is centered within the convexity of the elastomeric sealing strip 112. A centerline 126 is shown for purposes of determining these centered relationships.

It may be observed at this point that in the embodiments of FIGS. 13-16, there may be a one-to-one correspondence between each one of the magnets or individual pieces of magnetic reactive material of one sealing strip, such as the magnets 58 and 60 of the sealing strip 50 of FIG. 13, and each one of the magnets or second individual pieces of magnetic reactive material of the opposed sealing strip, such as the magnets or magnetic reactive materials 72, 74 of the sealing strip 52 in FIG. 13. It will be appreciated that one-to-one correspondence maximizes magnetic attraction while minimizing the number of embedded magnets or magnetic reactive materials. However, it would be possible to deviate from this concept. For example, a series of magnets may be provided in one sealing strip, while providing a continuous strip of magnetic reactive material in the corresponding sealing strip.

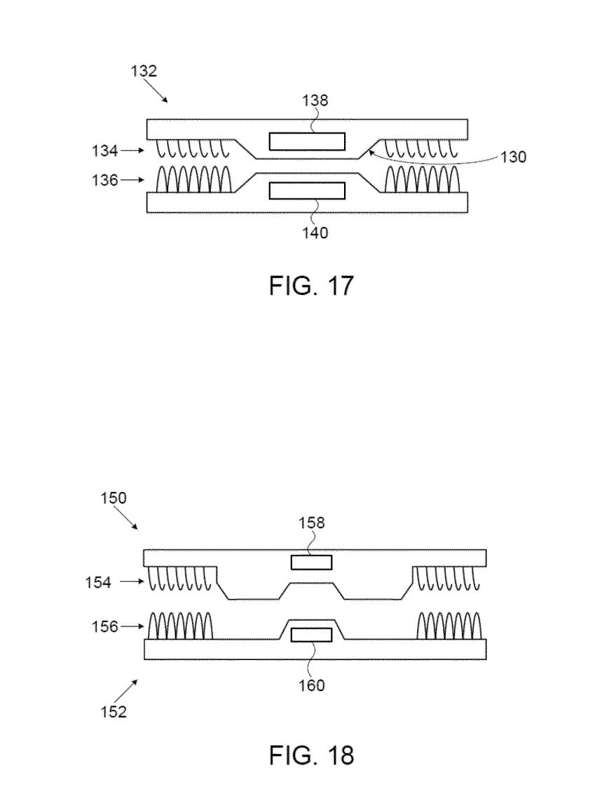

FIG. 17 shows that the characteristics of a sealing strip, such as the sealing strip 132, may display the characteristics for example of a sealing strip of the embodiments of FIGS. 13-15, while also having supplementary fastening elements such as the fastening elements 134 and 136 which may for example, have the characteristics of the fastening elements 22 and 26 of the embodiment of FIG. 1, as well as magnets (or magnetic reactive materials) 138, 140.

FIG. 18 shows that the characteristics of a sealing strip, such as the sealing strips 150 and 152, may display the characteristics for example of a sealing strip of the embodiment of FIG. 16, while also having supplementary fastening elements such as the fastening elements 154 and 156 which may for example have the characteristics of the fastening elements 22 and 26 of the embodiment of FIG. 1, as well as magnets (or magnetic reactive materials) 158, 160. In the embodiment of FIG. 18, the sealing strips 150 and 152 may display the respective concavity and convexity of the sealing strips 110, 112 of FIG. 16.

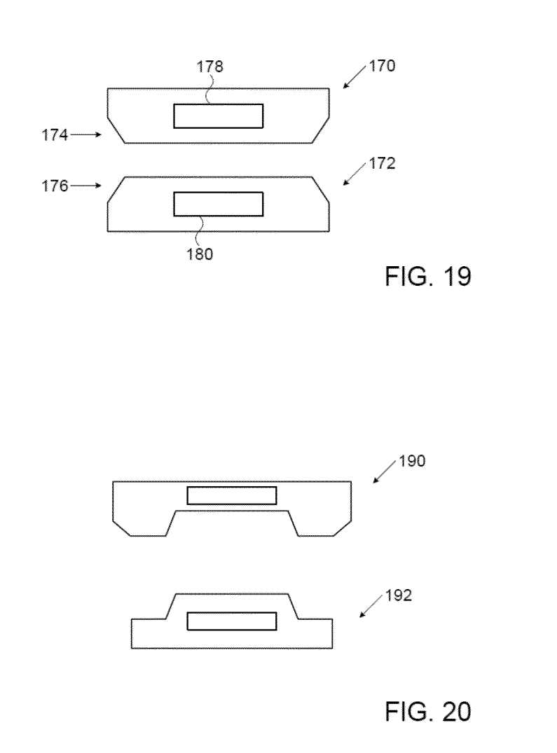

FIG. 19 shows that two complementing sealing strips may have characteristics of previously described embodiments, while lacking flanged portions. For example, first and second elastomeric sealing strips 170, 172 may have respective embedded regions 174, 176 containing magnets 178, 180, as seen in the embodiment of FIG. 15, but which first and second elastomeric sealing strips 170, 172 lack flanged portions such as the flanged portions 88, 90, 92, 94 of FIG. 15.

In a similar vein, and referring to FIG. 20, two complementing sealing strips 190, 192 may display concavity and convexity in the manner of the embodiment of FIG. 16, and may essentially duplicate the structure disclosed for the embodiment of FIG. 16, while lacking flanged portions.

In various embodiments of the present invention, part or all of the sealing apparatus is being manufactured using 3D printing, or additive manufacturing. Three-dimensional printing may be executed only for the sealing strips, or may be executed to manufacture both the sealing strips and the embedded magnets, or magnetic reactive materials, printed directly over the sealing strips. In various embodiments, the printing is executed directly onto the manufactured application.

Various 3D printing methods may be used. The main differences between processes are in the way layers are deposited to create parts and in the materials that are used. Some methods melt or soften material to produce the layers, e.g. selective laser melting (SLM) or direct metal laser sintering (DIALS), selective laser sintering (SLS), fused deposition modeling (FDM), or fused filament fabrication (FFT), while others cure liquid materials using different technologies, e.g. stereolithography (SLA). With laminated object manufacturing (LOM), thin layers are cut to shape and joined together (e.g. paper, polymer, metal). Each method has its own advantages and drawbacks, and a plurality of methods may be combined in the manufacturing process.

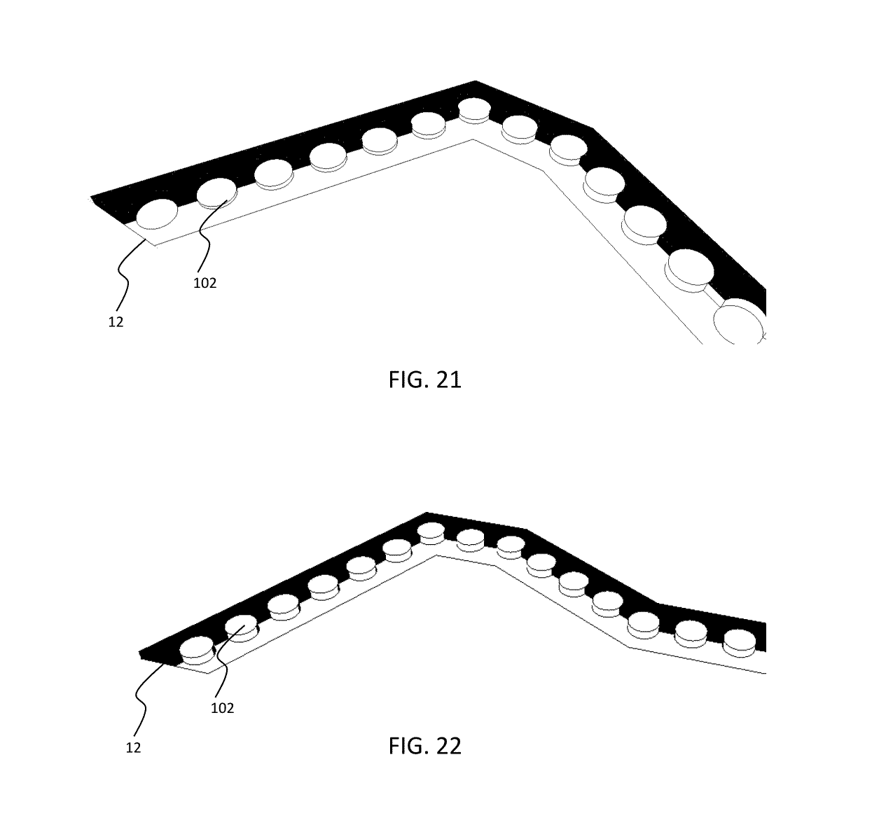

Reference is now made to FIG. 21, illustrating a cross section of the initial stages of building of the magnetic strip. In this embodiment, sealing strip 12 is manufactured by three-dimensional printing, and is provided with cavities 102 that will later on be embedded with magnets, or magnetic reactive materials. The magnets or magnetic reactive materials may be (pre-made, or may also be printed onto sealing strip 12 by an appropriate three-dimensional printing method, using magnetic or ferromagnetic materials.

According to some embodiments of FIG. 21, the plurality of cavities 38 are equally spaced between each other at a distance of about 3 mm. According to other embodiments, this distance is between about 2 mm to about 8 mm.

According to an embodiment of FIG. 21, the plurality of cavities 102 are non-full holes, full openings, but only partial cavities. According to other embodiments, the plurality of cavities 38 may be: niches, recesses, pits, openings, holes, full openings, apertures, and any combination thereof.

According to FIG. 21, first strip 12 and corresponding second strip 14, not shown, are characterized by a width of between about 10 mm to about 20 mm, and a thickness of about 1 to about 3 mm.

Reference is now made to FIG. 22, illustrating a cross section of later stages of the manufacturing of the magnetic strip, showing the magnetic cavities 102 built up to be flush and straightened later on. According to an embodiment of FIG. 22, magnetic elements which are predisposed to occupy cavities 102 are characterized by a diameter of about 6 mm, and a thickness of about 2 mm. According to other embodiments, the diameter is about between about 4 mm to about 10 mm, and the thickness is between about 1 to about 3 mm.

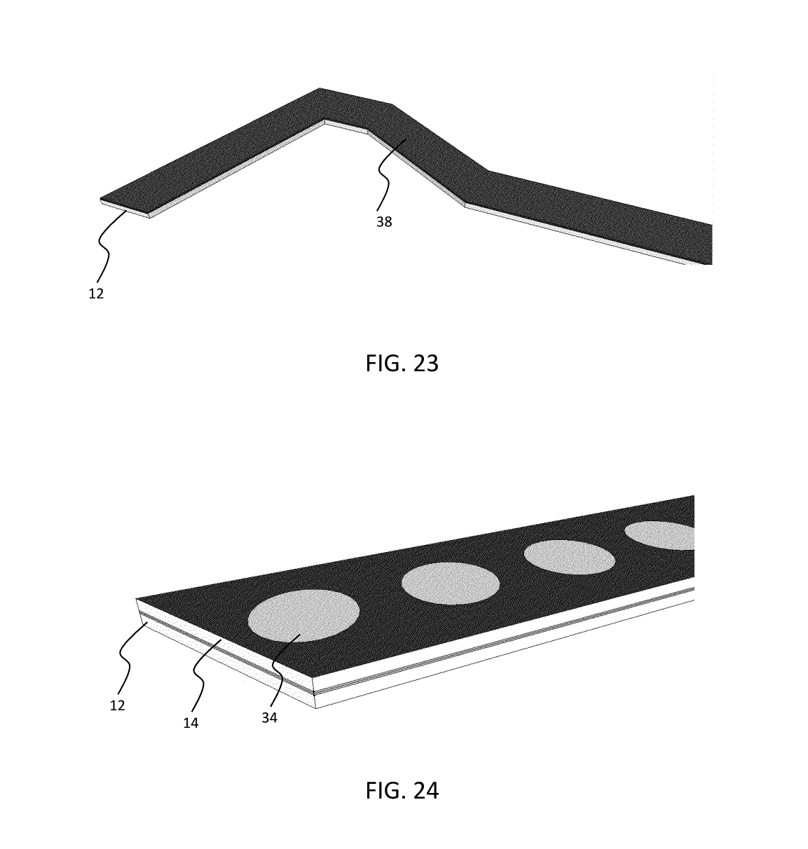

Reference is now made to FIG. 23, illustrating the addition of a laminating membrane 38, added after the manufacturing of the sealing strip, flushing the cavities and embedding the magnets or magnetic reactive material. Such a first membrane may be added onto the first sealing strip and a second membrane may also be added onto the second sealing strip. First membrane 38 and second membrane 40, not shown—corresponds to the second sealing strip, are characterized by a predetermined thickness which substantially preserves the magnetic attraction capabilities of the magnetic elements 34 of first and second strips, 12 and 14.

According to some embodiment of the present invention, the predetermined thickness of each of first and second membranes 38 and 40 is between about 0.05 mm to about 0.6 mm. Preferably, this thickness is between about 0.2 mm to about 0.4 mm.

The inventors of the present invention have additionally discovered that is order to provide a. stable sealing, membranes 38 and 40 have to be characterized by a predetermined static friction coefficient. The predetermined static friction coefficient of membranes 38 and 40 is adapted to prevent relative movement of membranes 38 and 40 with respect to each other, when mechanical deformations of sealing apparatus occur.

According to some embodiments of the present invention, the predetermined static friction coefficient is between about 0.01 to about 0.99. According to other embodiments of the present invention, the predetermined static friction coefficient is between about 0.1 to about 0.6. Preferable, the predetermined static friction coefficient is about 0.5.

It is important to emphasize that in order to provide stability of the sealing, according to some embodiment of the present invention, only one of the two main characteristics (the thickness and the friction coefficient) of the membranes is required.

Reference is now made to FIG. 24, illustrates an embodiment wherein the magnetic waterproof seal is comprised of two identical magnetic strips, comprising first and second sealing strips, 12 and 14, embedded with at least one magnetic material 34, and having opposing polarity. Both strips are totally smooth and are non-interlocking.

In an embodiment of the present invention there is one-to-one correspondence between each one of the first at least one magnetic materials and each one of the second magnetic materials.

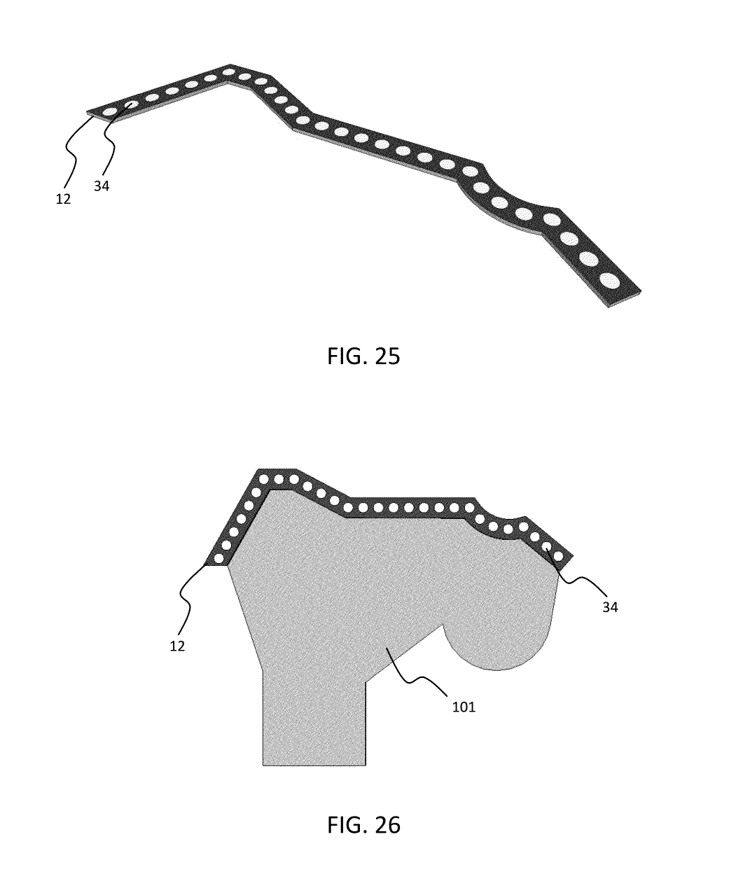

Reference is now made to FIG. 25, illustrating an embodiment of the three-dimensional printing of the magnetic strip, providing an irregular shape. This embodiment illustrates the crucial ability to create any irregular geometrical shape, thus bringing forth the novelty of the present invention, and its superiority above “standard” methods of production by extrusion or molding which continuously and forever produce the one and only shape that they were designed for.

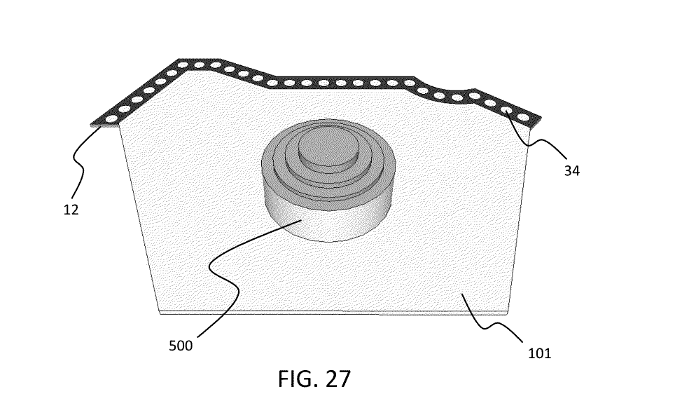

Reference is now made to FIG. 26, illustrating an embodiment of the three-dimensional printing of the sealing apparatus 101, exemplifying the flexibility of manufacturing available by the novel method disclosed in the present invention. This illustrates that not only the magnetic strip can be now made to irregular geometric shapes but also the actual pouch/waterproof container/pocket of the sealing apparatus can be adjusted to correspond to irregular shapes and when it is 3D injected.

Reference is now made to FIG. 27, illustrating an embodiment in which three-dimensional printing is being used to manufacture the pouch/waterproof container/pocket 101, and besides enabling the manufacturing of irregular shapes, the pouch can also be embedded with alternating and different materials to add other attributes to the pocket—for a non-limiting example as shown in FIG. 27, an extended camera insert 500.

According to other embodiment, said sealing apparatus is impermeable to other known materials (e.g., air, gas, dust, chemical, biological, etc.),

According to different embodiment of the present invention, the sealing apparatus is usable in fields selected from the group consisting of: packaging, storage, military, medical, agriculture, food, outdoor activities, construction, fashion, textile or any combination thereof.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements. For example, it is further contemplated by the inventors that the addition of multiple fastener elements and sealing elements to a given sealing apparatus would only increase the water impermeability of the apparatus. Thus, a sealing apparatus that increase the number of sealing elements and/or fastener elements should be treated as an equivalent to the apparatus described above and, therefore; would fall under the broadest interpretation of the following claims.

What is claimed is:

1. A sealing apparatus usable in manufactured applications, the apparatus comprising:
a. a first sealing strip having an embedded region embedded with a first at least one magnet or a first at least one magnet reactive material;
b. a second sealing strip having an embedded region embedded with a second at least one magnet or a second at least one magnet reactive material;
wherein a magnetic force of attraction is generated between the first sealing strip and the second sealing strip when the first and second sealing strips are brought together, thereby creating a seal;

2. The apparatus of claim 1, wherein at least one of the following is being held true:
a. said first sealing strip and second sealing strip are manufactured using three-dimensional printing;
b. said first and second at least one magnet or said first and second at least one magnet reactive material are manufactured using three-dimensional printing; and
c. said apparatus is directly three-dimensionally printed onto said manufactured application.
d. said manufactured application is made of a material selected from the group consisting of: rigid, non-rigid, semi-rigid, transparent, translucent, opaque, partially opaque, textile, glass, plastic, PVC, Perspex, wood, aluminum, vinyl, ceramics, metal, platinum, steel, wax and any combination thereof.

3. The apparatus of claim 1, wherein said three-dimensional printing is executed using a material selected from the group consisting of: an elastomeric material, a biodegradable material, a recyclable material, ABS plastic, polylactide, polyamide, glass filled polyamide, epoxy resins, silver, platinum, gold, titanium, steel, wax, photopolymers, polycarbonate, graphite, graphene, cornstarch, cellulose and any combination thereof.

4. The apparatus of claim 1, wherein said three-dimensional printing is executed in a method selected from the group consisting of: selective laser melting (SLM) or direct metal laser sintering (DMLS), selective laser sintering (SLS), fused deposition modeling (FDM),[28] or fused filament fabrication (FFF), stereolithography (SLA), laminated object manufacturing (LOM) and any combination thereof.

5. The apparatus of claim 1, wherein said first sealing strip further comprises a first flanged portion connected to and projecting from one side of the embedded region and integral with said embedded region; and a second flanged portion connected to and projecting from the other side of said embedded region and integral with said embedded region;
and said second sealing strip further comprises a third flanged portion connected to and projecting from one side of said embedded region and integral with said embedded region, and a fourth flanged portion connected to and projecting from the other side of the embedded region and integral with said embedded region.

6. The apparatus of claim 5, wherein at least one of the following is being held true:
a. said first, second, third and fourth flanged portions are manufactured using three-dimensional printing;
b. each one of the first at least one magnet or first at least one magnetic reactive material is located along the first sealing strip such that it comes into mutual magnetic attraction with one of the second at least one magnet or second at least one magnetic reactive material when the first elastomeric sealing strip is placed in longitudinal abutment with the second elastomeric sealing strip, and wherein a magnetic force of attraction is generated between the first sealing strip and the second sealing strip, thereby creating a seal; and
c. the first flanged portion is tapered such that its thickness progressively decreases with increasing distance from the center of the first sealing strip and the second flanged portion is tapered such that its thickness progressively decreases with increasing distance from the center of the first sealing strip, and the third flanged portion is tapered such that its thickness progressively decreases with increasing distance from the center of the second sealing strip and the fourth flanged portion is tapered such that its thickness progressively decreases with increasing distance from the center of the second sealing strip.

7. The apparatus of claim 5, wherein the flanged portions of said first and second sealing elements further comprise fastener elements carried on each side of said embedded regions, such that when the first sealing strip and the second sealing strips are brought together, the fastener elements engage one another.

8. The apparatus of claim 7, wherein at least one of the following is being held true:
a. said fastener elements are manufactured using three-dimensional printing; and
b. the fastener elements comprise hooks and hook-engageable fibers.

9. The sealing apparatus of claim 1, wherein the first sealing strip has a first footprint area, and the second sealing strip has a second footprint area equal in width to that of the first footprint area.

10. The sealing apparatus of claim 1, wherein the first embedded region has concavity, and the second embedded region has convexity which interfittingly cooperates with the concavity of the first embedded region.

11. The sealing apparatus of claim 10, wherein at least one the following is being held true:
a. the first embedded region has flat surfaces at its concavity, and the second embedded region has flat surfaces at its convexity; and
b. each one of said first at least one magnet or first at least one magnet reactive material are contained within the first embedded region and centered within the concavity of the first sealing strip, and wherein each one of said second at least one magnet or said second at least one magnet reactive material are centered within the convexity of the second sealing strip.

12. The sealing apparatus of claim 1, wherein there is one-to-one correspondence between each one of the first at least one magnet or first at least one magnetic reactive material and each one of the second at least one magnet or second at least one magnetic reactive material.

13. The sealing apparatus of claim 1, further comprising a first membrane connectable to said first sealing strip, such that said at least one magnet or at least one magnet reactive material are embedded within said first sealing strip and said first membrane; and, said sealing apparatus further comprises a second membrane connectable to said second sealing strip, such that said at least one magnet or at least one magnet reactive material are embedded within said second sealing strip and said second membrane.

14. A method of manufacturing a sealing apparatus usable in manufactured applications, characterized by:
a. providing a first sealing strip;
b. providing a second sealing strip;
c. embedding at least one magnet or at least one magnet reactive material onto said first sealing strip;
d. embedding at least one magnet or at least one magnet reactive material onto said second sealing strip;
e. incorporating said first and second sealing strips into said manufactured application; and
f. bringing together said first and second sealing strips, thereby generating a magnetic force of attraction between the first sealing strip and the second sealing strip, thus creating a seal.

15. The method of claim 18, further comprising at least one of the following steps:
a. three-dimensional printing said first and second sealing strips; and
b. three-dimensional printing said first and second at least one magnet or said first and second at least one magnet reactive material directly onto said first sealing strip or said second sealing strip, respectively.

16. The method of claim 18, further comprising at least one of the following steps:
a. incorporating said first and second sealing strips into said manufactured application is done by direct three-dimensional printing onto said manufactured application; and;
b. selecting said manufactured application to be made of a material from the group comprising of: rigid, non-rigid, semi-rigid, transparent, translucent, opaque, partially opaque, textile, glass, plastic, PVC, Perspex, wood, aluminum, vinyl, ceramics, metal, platinum, steel, wax and any combination thereof.

17. The method of claim 18, further comprising the step of executing said three-dimensional printing using a material selected from the group consisting of: an elastomeric material, a biodegradable material, a recyclable material, ABS plastic, polylactide, polyamide, glass filled polyamide, epoxy resins, silver, platinum, gold, titanium, steel, wax, photopolymers, polycarbonate, graphite, graphene, cornstarch, cellulose and any combination thereof.

18. The method of claim 18, further comprising the step of executing said three-dimensional printing using a method selected from the group consisting of: selective laser melting (SLM) or direct metal laser sintering (DMLS), selective laser sintering (SLS), fused deposition modeling (FDM),[28] or fused filament fabrication (FFF), stereolithography (SLA), laminated object manufacturing (LOM) and any combination thereof.

19. The method of claim 18, further comprising the steps of connecting a first flanged portion to one side of the embedded region of said first sealing strip being projected from one side of said embedded region and integral with said embedded region, and connecting a second flanged portion to second side of the embedded region of said first sealing strip being projected from second side of said embedded region and integral with said embedded region; and
connecting a third flanged portion to one side of the embedded region of said second sealing strip being projected from one side of said embedded region and integral with said embedded region, and connecting a fourth flanged portion to second side of the embedded region of said second sealing strip being projected from second side of said embedded region and integral with said embedded region.

20. The method of claim 23, further comprising at least one of the following steps:
a. three-dimensional printing said first, second, third and fourth flanged portions;
b. locating said each one of the first at least one magnet or first at least one magnetic reactive material along the first sealing strip such that it comes into mutual magnetic attraction with one of the second at least one magnet or second at least one magnetic reactive material when the first elastomeric sealing strip is placed in longitudinal abutment with the second elastomeric sealing strip, and wherein a magnetic force of attraction is generated between the first sealing strip and the second sealing strip, thereby creating a seal; and
c. incorporating fastener elements carried on each side of said embedded regions, such that when bringing together the first sealing strip and the second sealing strips, the fastener elements engage one another, and optionally, three-dimensional printing said fastener elements.
